(19) United States
(12) Patent Application Publication
(10) Pub. No.: US 2025/0168108 A1
(43) Pub. Date: May 22, 2025

(54) ROUTE SELECTION POLICY RULES FOR DIFFERENT NETWORKS

(71) Applicant: Lenovo (Singapore) Pte. Limited, Singapore (SG)

(72) Inventors: Dimitrios Karampatsis, Ruislp (GB); Genadi Vasilev Velev, Darmstadt (DE); Apostolis Salkintzis, Athens (GR)

(73) Assignee: Lenovo (Singapore) Pte. Limited, Singapore (SG)

(21) Appl. No.: 18/841,168

(22) PCT Filed: Apr. 27, 2022
(86) PCT No.: PCT/EP2022/061211

§ 371 Date: Aug. 23, 2024

(30) Foreign Application Priority Data
Feb. 25, 2022 (GR) 20220100172

(51) Int. Cl. H04L 45/302

(52) U.S. Cl. CPC H04L 45/306

(57) ABSTRACT

There is provided a user equipment apparatus registered with a first wireless communication network, the first wireless communication network identified by a first network identity. The user equipment apparatus comprises a receiver and a processor. The receiver is arranged to receive a route selection policy rule, the route selection policy rule including: an application descriptor, and a route selection descriptor, the route selection descriptor comprising a network identity. The processor is arranged to detect application traffic that matches the application descriptor and determine the network identity of the route selection descriptor matches an identity of the first wireless communication network. The processor is further arranged to apply the route selection descriptor to the detected application traffic upon determining the network identity of the route selection descriptor matches the identity of the first wireless communication network.

### FIELD

The subject matter disclosed herein relates generally to the field of implementing route selection policy rules for different networks. This document defines a user equipment apparatus registered with a first wireless communication network, a method of a user equipment apparatus, a network node in a first wireless communication network, and a method of a network node in a first wireless communication network.

### BACKGROUND

User Equipment (UE) Route Selection Policy (URSP) rules and the procedures for a UE to apply URSP rules are described in 3GPP TS 23.502 v17.3.0 and 3GPP TS 23.503 v17.3.0. The URSP rules contain a Traffic Descriptor that allows the UE to determine if a URSP rule matches application traffic. Traffic Descriptors include Application Descriptors which may define the operating system identity (OSID) and the application identity (OSAppID). Traffic Descriptors also include IP flow descriptors such as the target address of application traffic, a requested Data Network Name by the application, and/or a connection capability requested by an application (e.g. an IP Multimedia Subsystem (IMS) connection).

A UE with a valid International Mobile Subscriber Identifier may roam from its home public land mobile network (PLMN) and access service in the roamed to area by using a visited PLMN. If a communication has been established, the UE will in principle not suffer an interruption within the PLMN area.

### SUMMARY

A problem with existing UE Route Selection Policy Rules is that they can be only set by the Home PLMN. Further, such rules are applied universally by a UE without regard for which PLMN it is registered with.

Disclosed herein are procedures for implementing route selection policy rules for different networks and/or visited network identity. Said procedures may be implemented by user equipment and at least one node of at least one wireless communication networks.

There is provided a user equipment apparatus registered with a first wireless communication network, the first wireless communication network identified by a first network identity. The user equipment apparatus comprises a receiver and a processor. The receiver is arranged to receive a route selection policy rule, the route selection policy rule including: an application descriptor, and a route selection descriptor, the route selection descriptor comprising a network identity. The processor is arranged to detect application traffic that matches the application descriptor and determine the network identity of the route selection descriptor matches an identity of the first wireless communication network. The processor is further arranged to apply the route selection descriptor to the detected application traffic upon determining the network identity of the route selection descriptor matches the identity of the first wireless communication network.

There is provided a method of a user equipment apparatus, the user equipment apparatus registered with a first wireless communication network, the first wireless communication network identified by a first network identity. The method comprises receiving a route selection policy rule, the route selection policy rule including: an application descriptor, and a route selection descriptor, the route selection descriptor comprising a network identity. The method further comprises detecting application traffic that matches the application descriptor, and determining whether the network identity of the route selection descriptor matches an identity of the first wireless communication network. The method further comprises applying the route selection descriptor to the detected application traffic upon determining the network identity of the route selection descriptor matches the identity of the first wireless communication network.

There is further provided a network node in a first wireless communication network, the network node comprising a processor and a transmitter. The processor is arranged to construct a route selection policy rule including: an application descriptor and a route selection descriptor, the route selection descriptor comprising a network identity. The network identity identifies a second wireless communication network, and the route selection policy rule defines a route for application traffic when a user equipment apparatus is registered in the second wireless communication network. The transmitter is arranged to transmit the route selection policy rule to the user equipment apparatus.

There is further provided a method of a network node in a first wireless communication network. The method comprises constructing a route selection policy rule including: an application descriptor, and a route selection descriptor, and a route selection descriptor comprising a network identity. The network identity identifies a second wireless communication network, and the route selection policy rule defines a route for application traffic when a user equipment apparatus is registered in the second wireless communication network. The method further comprises transmitting the route selection policy rule to the user equipment apparatus.

There is further provided a network node in the first wireless communication network. The network node comprises a receiver arranged to receive a request from an application function (AF) in a second wireless communication network, the request comprising service parameters identifying both a first application and a second wireless communication network. The network node further comprises a processor arranged to store the service parameters in a Unified Data Repository (UDR) of the first wireless communication network. The network node may be a Network Exposure Function (NEF).

There is further provided a method in a network node in a first wireless communication network. The network node may be a NEF 132, 152, 232, 932. The network node may comprise a network node 400 as described with reference to FIG. 4. The method comprises receiving a request from an application function (AF) in a second wireless communication network, the request comprising service parameters identifying both a first application and a second wireless communication network. The method further comprises storing the service parameters in a Unified Data Repository (UDR) of the first wireless communication network.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for implementing route selection policy rules for different networks will now be described, by way of example only, with reference to the accompanying drawings, in which:

FIG. 1 illustrates a UE, a Home PLMN and a Visited PLMN;

FIG. 2 illustrates a procedure for service specific parameter provisioning in a Home PLMN;

FIG. 3 depicts a user equipment apparatus;

FIG. 4 depicts a network node;

FIG. 5 illustrates a method of a user equipment apparatus;

FIG. 6 illustrates a method of a network node in a first wireless communication network;

FIG. 7 illustrates another method of a network node in a first wireless communication network;

FIG. 8 illustrates a method of a network node in a second wireless communication network; and

FIG. 9 is a signaling diagram illustrating a procedure to for a VPLMN to influence URSP rules for UEs roaming from a different PLMN.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding figures. Like numbers refer to like elements in all figures.

Since Release 15 onwards URSP rules have been defined to allow a UE to determine how to route application traffic via the mobile communication network either via 3GPP access or via non-3GPP access via an untrusted or trusted Wireless Local Area Network (WLAN) access or route the traffic non-seamlessly bypassing the mobile communication network via a WLAN connection. The URSP rules and the procedures for the UE to apply URSP rules are described in 3GPP TS 23.502 v17.3.0 and 3GPP TS 23.503 v17.3.0 (URSP rules definitions and procedures are included from version 15.0.0 onwards of 23.502 and 23.503).

A URSP rule contains a Traffic Descriptor that allows the UE to determine if the URSP rule matches application traffic. Traffic Descriptors include: Application Descriptors (OSID/OSAppID), IP flow descriptors (e.g. target address of application traffic, a requested Data Network Name (DNN) by the application or a connection capability requested by an application (e.g. an IMS connection).

Each URSP rule contains a Route Selection Descriptor (RSD) that describes to the UE how to route a Packet Data Unit (PDU) session for the matching application traffic. The RSD includes one or more of the following: Session and Service Continuity (SSC) Mode Selection, Network Slice Selection, Data Network Name (DNN) Selection, Packet Data Unit (PDU) Session Type Selection, Non-Seamless Offload indication, Access Type preference. The UE routes the application traffic via the PDU session that matches the RSD components via 3GPP or non-3GPP access as defined by the URSP rule.

Currently URSP rules are only provided to a UE from the Policy Control Function (PCF) of the HPLMN (i.e. H-PCF). A UE uses the provisioned URSP rules in any PLMN that the UE may register to. When the UE is roaming the PCF at the V-PLMN (i.e. V-PCF) is not allowed to create or provision URSP rules but is allowed to create and provision ANDSP (Access Network Discovery and Selection Policy) rules. The PCF provisions the UE with URSP and/or ANDSP policies within UE Policy information. UE Policy information is provided to the UE via Non-Access Stratum (NAS) signaling. The PCF allocates the URSP and ANDSP rules within policy sections within the UE policy information. Each policy section is identified by a specific policy section identifier. The PCF stores the policy sections and policy section identifier in a database which is used as a means for the PCF to determine if the UE requires updated policies. When the UE registers the UE includes in the registration request the policy section identifiers associated with the policy sections stored in the UE that allows the PCF (both in VPLMN and HPLMN) to identify if updated policies are required at the UE.

In addition, as part of Release 17 work, it is possible for an Application Function to indicate to an HPLMN to create URSP rules for application traffic. This is described in clause 4.15.6.10 of 3GPP TS 23.502 v17.3.0, which states that an AF is allowed to provide guidance for URSP determination to a 5G system via NEF; the home PCF determines the URSP for the UE. Section 5.2.5.6.1 of 3GPP TS 23.502 v17.3.0 states that in the case of roaming, the URSP rules are provided by H-PCF and the ANDSP rules may be provided by V-PCF or H-PCF or both.

This document provides a solution for an HPLMN to identify that specific URSP rules are needed in a VPLMN. This document also provides a solution for how URSP rules are configured to allow the UE to determine to apply the URSP rules in a particular VPLMN.

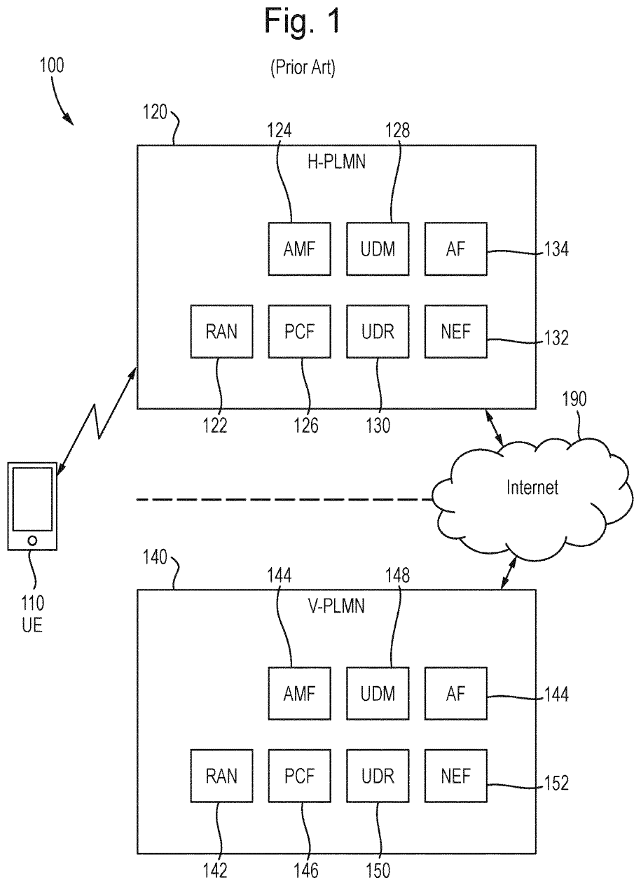

FIG. 1 illustrates a UE 110, an HPLMN 120 and a VPLMN 140. UE 110 may establish a connection with the internet 190 via the HPLMN 120, or, when roaming, via the VPLMN 140. HPLMN 120 comprises a Radio Access Network (RAN) 122, an Application Management Function (AMF) 124, a Policy Control Function (PCF) 126, a User Data Management (UDM) 128, a User Data Repository (UDR) 130, a Network Exposure Function (NEF) 132, and an Application Function (AF) 134. Similarly, the VPLMN 140 comprises a RAN 142, an AMF 144, a PCF 146, a UDM 148, a UDR 150, a NEF 152, and an AF 154.

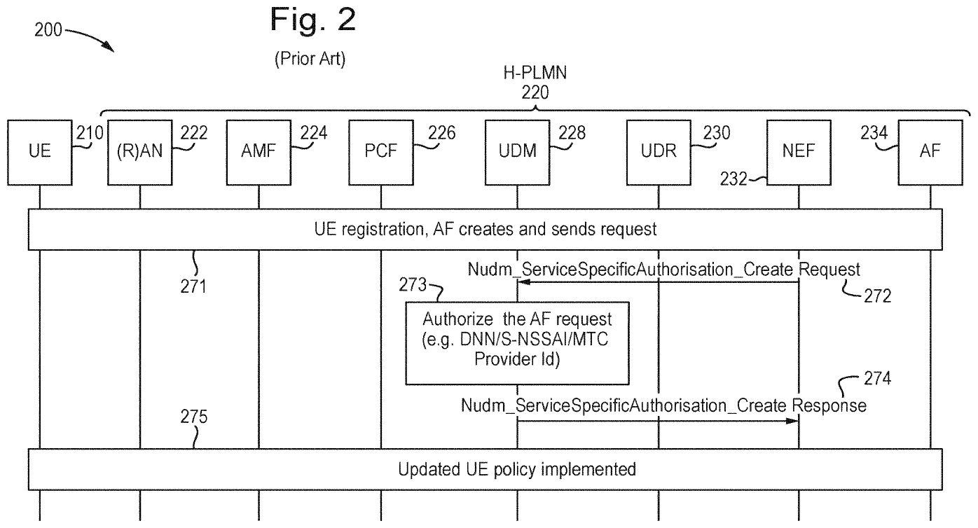

FIG. 2 illustrates a procedure for service specific parameter provisioning in a HPLMN. Section 4.15.6.7 of 3GPP TS 23.502 v 17.3.0 describes service specific parameter provisioning. The AF 234 uses the Nnef_ServiceParameter service to provide service specific parameters to the HPLMN 220 and the UE 210.

At 271, the AF 234 invokes an Nnef_ServiceParameter_Create service operation. The request may include subscription information to the report of the outcome of UE 210 Policy delivery. To update or remove an existing request, the AF 234 invokes an Nnef_ServiceParameter_Update or Nnef_ServiceParameter_Delete service operation together with the corresponding Transaction Reference ID which was provided to the AF 234 in Nnef_ServiceParameter_Create response message. The AF 234 sends its request to the NEF 232. The NEF 232 authorizes the AF request.

At 272, NEF 232 sends a Nudm_ServiceSpecificAuthorisation_Create Request message to UDM 228.

At 273, the UDM 228 authorizes the AF request. The requested service specific parameter may be a DNN, a S-NSSAI or a Machine Type Communication Provider Identity.

At 274, the UDM 228 responds to the AF 234 with a Nudm_ServiceSpecific Authorisation_Create_Response message.

At 275, the PCF 226 initiates UE Policy delivery as specified in clause 4.2.4.3 of 3GPP TS 23.502 v 17.3.0. Further, if the AF 234 has subscribed to notifications about the outcome of UE Policies delivery due to Service specific parameter provisioning targeting a single UE and the PCF is notified of UE Policy Container from the AMF, the PCF notifies the UE Policy delivery result contained in the UE Policy container as the outcome of the procedure to NEF by sending Npcf_EventExposure_Notify.

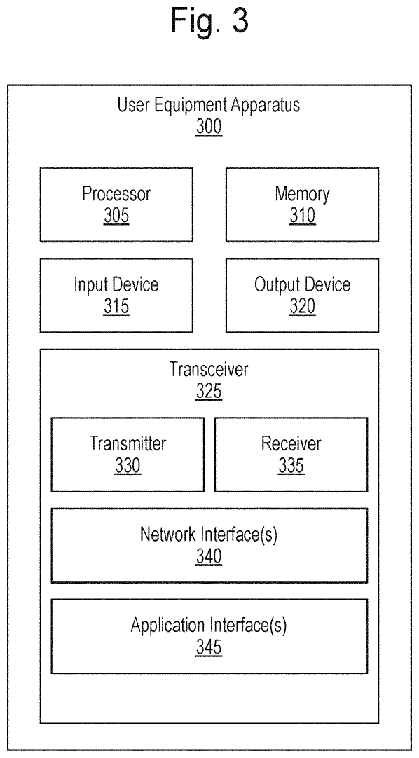

FIG. 3 depicts a user equipment apparatus 300 that may be used for implementing the methods described herein. The user equipment apparatus 300 is used to implement one or more of the solutions described above. The user equipment apparatus 300 includes a processor 305, a memory 310, an input device 315, an output device 320, and a transceiver 325.

The input device 315 and the output device 320 may be combined into a single device, such as a touchscreen. In some implementations, the user equipment apparatus 300 does not include any input device 315 and/or output device 320. The user equipment apparatus 300 may include one or more of: the processor 305, the memory 310, and the transceiver 325, and may not include the input device 315 and/or the output device 320.

As depicted, the transceiver 325 includes at least one transmitter 330 and at least one receiver 335. The transceiver 325 may communicate with one or more cells (or wireless coverage areas) supported by one or more base units. The transceiver 325 may be operable on unlicensed spectrum. Moreover, the transceiver 325 may include multiple UE panels supporting one or more beams. Additionally, the transceiver 325 may support at least one network interface 340 and/or application interface 345. The application interface(s) 345 may support one or more APIs. The network interface(s) 340 may support 3GPP reference points, such as Uu, N1, PC5, etc. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a central processing unit (“CPU”), a graphics processing unit (“GPU”), an auxiliary processing unit, a field programmable gate array (“FPGA”), or similar programmable controller. The processor 305 may execute instructions stored in the memory 310 to perform the methods and routines described herein. The processor 305 is communicatively coupled to the memory 310, the input device 315, the output device 320, and the transceiver 325.

The processor 305 may control the user equipment apparatus 300 to implement the above-described UE behaviors. The processor 305 may include an application processor (also known as “main processor”) which manages application-domain and operating system (“OS”) functions and a baseband processor (also known as “baseband radio processor”) which manages radio functions.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to implement a traffic category field as describe above. The memory 310 may also store program code and related data, such as an operating system or other controller algorithms operating on the apparatus 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 320 may include a wearable display separate from, but communicatively coupled to, the rest of the user equipment apparatus 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 communicates with one or more network functions of a mobile communication network via one or more access networks. The transceiver 325 operates under the control of the processor 305 to transmit messages, data, and other signals and also to receive messages, data, and other signals. For example, the processor 305 may selectively activate the transceiver 325 (or portions thereof) at particular times in order to send and receive messages.

The transceiver 325 includes at least one transmitter 330 and at least one receiver 335. The one or more transmitters 330 may be used to provide UL communication signals to a base unit of a wireless communications network. Similarly, the one or more receivers 335 may be used to receive DL communication signals from the base unit. Although only one transmitter 330 and one receiver 335 are illustrated, the user equipment apparatus 300 may have any suitable number of transmitters 330 and receivers 335. Further, the transmitter(s) 330 and the receiver(s) 335 may be any suitable type of transmitters and receivers. The transceiver 325 may include a first transmitter/receiver pair used to communicate with a mobile communication network over licensed radio spectrum and a second transmitter/receiver pair used to communicate with a mobile communication network over unlicensed radio spectrum.

The first transmitter/receiver pair may be used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 325, transmitters 330, and receivers 335 may be implemented as physically separate components that access a shared hardware resource and/or software resource, such as for example, the network interface 340.

One or more transmitters 330 and/or one or more receivers 335 may be implemented and/or integrated into a single hardware component, such as a multi-transceiver chip, a system-on-a-chip, an Application-Specific Integrated Circuit (“ASIC”), or other type of hardware component. One or more transmitters 330 and/or one or more receivers 335 may be implemented and/or integrated into a multi-chip module. Other components such as the network interface 340 or other hardware components/circuits may be integrated with any number of transmitters 330 and/or receivers 335 into a single chip. The transmitters 330 and receivers 335 may be logically configured as a transceiver 325 that uses one more common control signals or as modular transmitters 330 and receivers 335 implemented in the same hardware chip or in a multi-chip module.

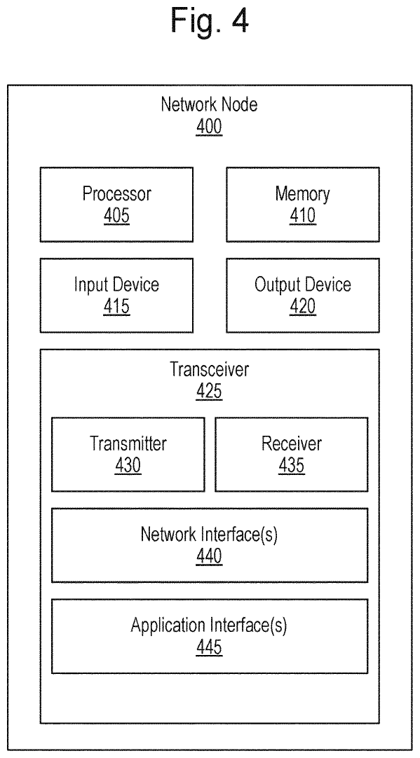

FIG. 4 depicts further details of the network node 400 that may be used for implementing the methods described herein. The network node 400 may be one implementation of an entity in the wireless communications network. The network node 400 includes a processor 405, a memory 410, an input device 415, an output device 420, and a transceiver 425.

The input device 415 and the output device 420 may be combined into a single device, such as a touchscreen. In some implementations, the network node 400 does not include any input device 415 and/or output device 420. The network node 400 may include one or more of: the processor 405, the memory 410, and the transceiver 425, and may not include the input device 415 and/or the output device 420.

As depicted, the transceiver 425 includes at least one transmitter 430 and at least one receiver 435. Here, the transceiver 425 communicates with one or more remote units 200. Additionally, the transceiver 425 may support at least one network interface 440 and/or application interface 445. The application interface(s) 445 may support one or more APIs. The network interface(s) 440 may support 3GPP reference points, such as Uu, N1, N2 and N3. Other network interfaces 440 may be supported, as understood by one of ordinary skill in the art.

The processor 405 may include any known controller capable of executing computer-readable instructions and/or capable of performing logical operations. For example, the processor 405 may be a microcontroller, a microprocessor, a CPU, a GPU, an auxiliary processing unit, a FPGA, or similar programmable controller. The processor 405 may execute instructions stored in the memory 410 to perform the methods and routines described herein. The processor 405 is communicatively coupled to the memory 410, the input device 415, the output device 420, and the transceiver 425.

The memory 410 may be a computer readable storage medium. The memory 410 may include volatile computer storage media. For example, the memory 410 may include a RAM, including dynamic RAM (“DRAM”), synchronous dynamic RAM (“SDRAM”), and/or static RAM (“SRAM”). The memory 410 may include non-volatile computer storage media. For example, the memory 410 may include a hard disk drive, a flash memory, or any other suitable non-volatile computer storage device. The memory 410 may include both volatile and non-volatile computer storage media.

The memory 410 may store data related to establishing a multipath unicast link and/or mobile operation. For example, the memory 410 may store parameters, configurations, resource assignments, policies, and the like, as described above. The memory 410 may also stores program code and related data, such as an operating system or other controller algorithms operating on the network node 400.

The input device 415 may include any known computer input device including a touch panel, a button, a keyboard, a stylus, a microphone, or the like. The input device 415 may be integrated with the output device 420, for example, as a touchscreen or similar touch-sensitive display. The input device 415 may include a touchscreen such that text may be input using a virtual keyboard displayed on the touchscreen and/or by handwriting on the touchscreen. The input device 415 may include two or more different devices, such as a keyboard and a touch panel.

The output device 420 may be designed to output visual, audible, and/or haptic signals. The output device 420 may include an electronically controllable display or display device capable of outputting visual data to a user. For example, the output device 420 may include, but is not limited to, an LCD display, an LED display, an OLED display, a projector, or similar display device capable of outputting images, text, or the like to a user. As another, non-limiting, example, the output device 420 may include a wearable display separate from, but communicatively coupled to, the rest of the network node 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

The output device 420 may include one or more speakers for producing sound. For example, the output device 420 may produce an audible alert or notification (e.g., a beep or chime). The output device 420 may include one or more haptic devices for producing vibrations, motion, or other haptic feedback. All, or portions, of the output device 420 may be integrated with the input device 415. For example, the input device 415 and output device 420 may form a touchscreen or similar touch-sensitive display. The output device 420 may be located near the input device 415.

The transceiver 425 includes at least one transmitter 430 and at least one receiver 435. The one or more transmitters 430 may be used to communicate with the UE, as described herein. Similarly, the one or more receivers 435 may be used to communicate with network functions in the PLMN and/or RAN, as described herein. Although only one transmitter 430 and one receiver 435 are illustrated, the network node 400 may have any suitable number of transmitters 430 and receivers 435. Further, the transmitter(s) 430 and the receiver(s) 435 may be any suitable type of transmitters and receivers.

There is provided a user equipment apparatus registered with a first wireless communication network, the first wireless communication network identified by a first network identity. The user equipment apparatus may comprise a UE 110, 210, 510, and/or 910 described herein. The user equipment apparatus comprises a receiver and a processor. The user equipment apparatus may be a user equipment apparatus 300 as described with reference to FIG. 3, and comprising a processor 305, a receiver 335 and a transmitter 330. The receiver is arranged to receive a route selection policy rule, the route selection policy rule including: an application descriptor, and a route selection descriptor, the route selection descriptor comprising a network identity. The processor is arranged to detect application traffic that matches the application descriptor and determine the network identity of the route selection descriptor matches an identity of the first wireless communication network. The processor is further arranged to apply the route selection descriptor to the detected application traffic upon determining the network identity of the route selection descriptor matches the identity of the first wireless communication network.

By applying a rule that includes a network identity, the network identity described above, the user equipment is able to tailor route selection according to the identity of the network it is registered with. In the above example the network identity of the route selection descriptor matches the first network identity and thus the route selection policy rule is applied to application traffic. However, if the user equipment were to roam to a different network, say a second wireless communication network, and register thereto, then a route selection policy rule comprising a network identity that is the first network identity would not be applied to the application traffic.

The first wireless communication network may be a home network for the user equipment. A second wireless communication network may be a visited network for the user equipment. The user equipment may connect to the second wireless communication network while roaming. The route selection policy rule may be received from the first wireless communication network.

The first wireless communication network may be a visited network for the user equipment. A second wireless communication network may be a home network for the user equipment. The route selection policy rule may be received from the second wireless communication network.

The route selection policy rule may comprise a route selection component. The route selection component may give different characteristics of the route that should be selected for the application traffic. The route selection component may comprise at least one of: SSC mode selection; network slice selection; DNN selection; PDU Session Type Selection; Non-Seamless Offload indication; Proximity-based services (ProSe) Layer-3 UE-to-Network Relay Offload indication; Access Type preference; PDU Session Pair ID; and Retransmission Sequence Number (RSN).

Any number of route selection components can be set in a route selection policy rule. The number of route selection components set in a route selection policy rule is dependent on the requirements of the wireless communication network.

The route selection policy rule may comprise a route selection validation criteria, the route selection validation criteria comprising at least one of: the network identity; a time window; and a location criteria. The route selection validation criteria define the circumstances in which the route selection policy rule must be applied. These are optional and allow for a route selection policy rule to be applied only within a particular network, a particular geographical area, or during a particular time window, for example.

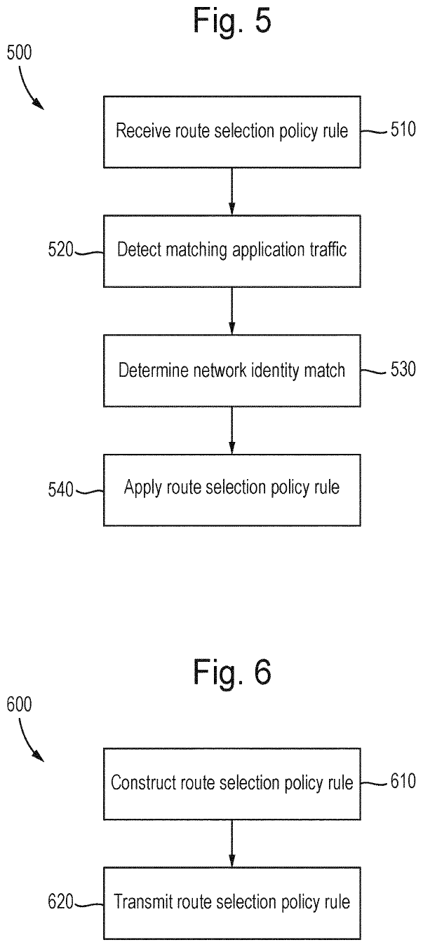

FIG. 5 illustrates a method 500 of a user equipment apparatus, the user equipment apparatus registered with a first wireless communication network, the first wireless communication network identified by a first network identity. The user equipment apparatus may comprise a UE 110, 210, 300, 510, and/or 910 described herein. The method 500 comprises receiving 510 a route selection policy rule, the route selection policy rule including: an application descriptor, and a route selection descriptor, the route selection descriptor comprising a network identity. The method 500 further comprises detecting 520 application traffic that matches the application descriptor, and determining 530 whether the network identity of the route selection descriptor matches an identity of the first wireless communication network. The method 500 further comprises applying 540 the route selection descriptor to the detected application traffic upon determining the network identity of the route selection descriptor matches the identity of the first wireless communication network.

By applying a rule that includes a network identity, the network identity described above, the user equipment is able to tailor route selection according to the identity of the network it is registered with. In the above example the network identity of the route selection descriptor matches the first network identity and thus the route selection policy rule is applied to application traffic. However, if the user equipment were to roam to a different network, say a second wireless communication network, and register thereto, then a route selection policy rule comprising a network identity that is the first network identity would not be applied to the application traffic.

There is further provided a network node in a first wireless communication network, the network node comprising a processor and a transmitter. The network node may be a PCF 126, 146, 226 and/or 926 as described herein. The network node may comprise a network node 400 as described with reference to FIG. 4, and comprising a processor 405, a receiver 435, and a transmitter 430. The processor is arranged to construct a route selection policy rule including: an application descriptor and a route selection descriptor, the route selection descriptor comprising a network identity. The network identity identifies a second wireless communication network, and the route selection policy rule defines a route for application traffic when a user equipment apparatus is registered in the second wireless communication network. The transmitter is arranged to transmit the route selection policy rule to the user equipment apparatus.

By providing to the user equipment a rule that includes a network identity the first wireless communication network is able to set route selection according to the identity of the network the user equipment is registered with. In the above example the network identity of the route selection descriptor matches the first network identity and thus the route selection policy rule is applied to application traffic. However, if the user equipment were to roam to a different network, say a second wireless communication network, and register thereto, then a route selection policy rule comprising a network identity that is the first network identity would not be applied to the application traffic.

The first wireless communication network is a home network for the user equipment, and wherein the second wireless communication network is a visited network for the user equipment. Accordingly, a first wireless communication network can set a route selection policy rule for a user equipment to apply in the event that it roams to a second wireless communication network.

The network node may comprise a policy control function. The network node may further comprise a receiver arranged to receive a notification of updated service parameters from a UDR in the first wireless communication network. The UDR in the first wireless communication network may receive updated SSI from an application function in the second wireless communication network. The service parameters may be Service Specific Information.

The processor may be further arranged to determine from the updated service parameters a route for application traffic in the second wireless communication network. The processor may construct the route selection policy rule from the updated service parameters in accordance with the determined route for application traffic in the second wireless communication network. The updated service parameters may be for a UE, a group of UEs or a S-NSSAI/DNAI combination. S-NSSAI refers to Network Slice Selection Assistance Information, which is used to uniquely identify a Network Slice. DNAI refers to a Data Network Access Identifier, which identifies the user plane access to one or more Data Networks at which specific applications can be found.

FIG. 6 illustrates a method 600 of a network node in a first wireless communication network. The network node may be a PCF 126, 146, 226, 400 and/or 926 as described herein. The method 600 comprises constructing 610 a route selection policy rule including: an application descriptor, and a route selection descriptor, and a route selection descriptor comprising a network identity. The network identity identifies a second wireless communication network, and the route selection policy rule defines a route for application traffic when a user equipment apparatus is registered in the second wireless communication network. The method 600 further comprises transmitting 620 the route selection policy rule to the user equipment apparatus.

There is further provided a network node in a first wireless communication network. The network node may be a NEF 132, 152, 232, 932. The network node may comprise a network node 400 as described with reference to FIG. 4, and comprising a processor 405, a receiver 435, and a transmitter 430. The network node comprises a receiver arranged to receive a request from an application function (AF) in a second wireless communication network, the request comprising service parameters identifying both a first application and a second wireless communication network. The network node further comprises a processor arranged to store the service parameters in a Unified Data Repository (UDR) of the first wireless communication network.

The network node may be a Network Exposure Function (NEF). The stored service parameters are applied by a Policy Control Function (PCF) in the first wireless communication network to create a route selection policy rule. The route selection policy rule indicates how the traffic of the first application is to be routed by a remote unit when the remote unit is registered with the second wireless communication network. The service parameters may be Service Specific Information.

There is further provided a method in a network node in a first wireless communication network. The network node may be a NEF 132, 152, 232, 932. The network node may comprise a network node 400 as described with reference to FIG. 4. The method comprises receiving a request from an application function (AF) in a second wireless communication network, the request comprising service parameters identifying both a first application and a second wireless communication network. The method further comprises storing the service parameters in a Unified Data Repository (UDR) of the first wireless communication network.

There is further provided a network node in a first wireless communication network. The network node may be a PCF 126, 146, 226 and/or 926 as described herein. The network node may comprise a network node 400 as described with reference to FIG. 4, and comprising a processor 405, a receiver 435, and a transmitter 430. The network node comprises a receiver, a processor and a transmitter. The receiver is arranged to receive, from an application function in a second wireless communication network, application guidance on route selection policy rule determination. The processor is arranged to construct a route selection policy rule using the application guidance, the route selection policy rule including: an application descriptor, and a route selection descriptor comprising a network identity, wherein the network identity identifies the second wireless communication network, and the route selection policy rule defines a route for application traffic when a user equipment apparatus is registered in the second wireless communication network. The transmitter is arranged to transmit the route selection policy rule to the user equipment apparatus.

The network node in the first wireless communication network may receive the application guidance on route selection policy rule determination from the application function in the second wireless communication network via a Network Exposure Function (NEF) in the first wireless communication network.

By receiving application guidance on route selection policy rule determination from an application function in a second wireless communication network the network node is able to create a route selection policy rule having a route selection descriptor that includes the network identity of the second wireless communication network. Such a route selection policy rule is then transmitted to the user equipment such that the first wireless communication network is able to set route selection according to the identity of the network the user equipment is registered with. For example, if the network identity of the route selection descriptor matches the network identity of the wireless communication network the user equipment is registered with, then the route selection policy rule is applied to application traffic. In the above case the rule is set for a second wireless communication network that a user equipment may roam to. If the user equipment were to roam to the second wireless communication network, and register thereto, then the route selection policy rule comprising a network identity that is the second network identity would be applied to the application traffic that matches the route selection policy rule.

The application guidance may include a validity condition. The validity condition may comprise at least one of: an identity of the second wireless communication network; a plurality of identities of wireless communication networks; or an identity of an application.

The route selection policy rule may define a route for application traffic when a user equipment apparatus is registered in any wireless communication network having an identity matching one of the plurality of identities of wireless communication networks.

The transmitter may be further arranged to transmit the route selection policy rule to the user equipment apparatus. The route selection policy rule may be transmitted to the user equipment apparatus when the user equipment apparatus is registered with the first wireless communication network.

The network node may be a policy control function. The receiver may be further arranged to receive a notification of updated service parameters from a UDR in the first wireless communication network. The service parameters may be Service Specific Information.

The processor may be further arranged to determine from the service parameters a route for application traffic in a second wireless communication network. The processor may construct the route selection policy rule from the service parameters in accordance with the determined route. The updated service parameters may be for a UE, a group of UEs, or a S-NSSAI/DNAI combination.

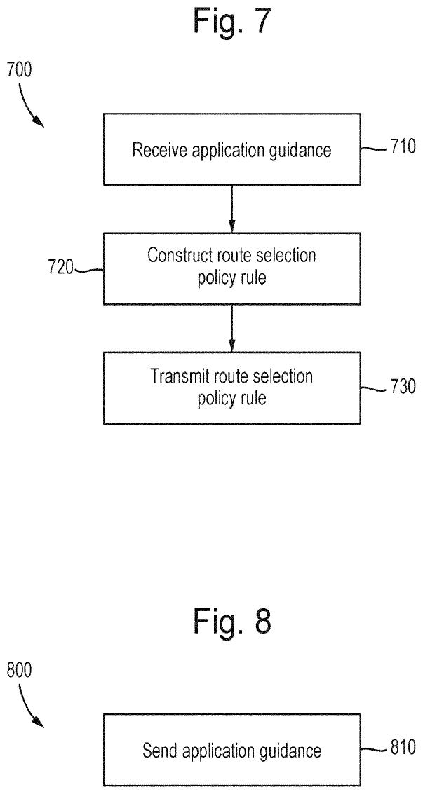

FIG. 7 illustrates a method 700 of a network node in a first wireless communication network. The network node may be a PCF 126, 146, 226, 400 and/or 926 as described herein. The method 700 comprises receiving 710, from an application function in a second wireless communication network, application guidance on route selection policy rule determination. The method 700 further comprises constructing 720 a route selection policy rule using the application guidance. The route selection policy rule includes: an application descriptor, and a route selection descriptor comprising a network identity, wherein the network identity identifies the second wireless communication network, and the route selection policy rule defines a route for application traffic when a user equipment apparatus is registered in the second wireless communication network. The method further comprising transmitting 730 the route selection policy rule to the user equipment apparatus.

By receiving application guidance on route selection policy rule determination from an application function in a second wireless communication network the network node is able to create a route selection policy rule having a route selection descriptor that includes the network identity of the second wireless communication network. Such a route selection policy rule is then transmitted to the user equipment such that the first wireless communication network is able to set route selection according to the identity of the network the user equipment is registered with. For example, if the network identity of the route selection descriptor matches the network identity of the wireless communication network the user equipment is registered with, then the route selection policy rule is applied to application traffic. In the above case the rule is set for a second wireless communication network that a user equipment may roam to. If the user equipment were to roam to the second wireless communication network, and register thereto, then the route selection policy rule comprising a network identity that is the second network identity would be applied to the application traffic that matches the route selection policy rule.

There is further provided a network node in a second wireless communication network. The network node may comprise an AF 134, 154, 234 and/or 954 as described herein. The network node may comprise a network node 400 as described with reference to FIG. 4, and comprising a processor 405, a receiver 435, and a transmitter 430. The network node comprises a transmitter arranged to send, to a policy control function in a first wireless communication network, application guidance on route selection policy rule determination.

The network node in the second wireless communication network may be arranged to send the application guidance on route selection policy rule determination to the policy control function in the first wireless communication network via a Network Exposure Function (NEF) in the first wireless communication network.

By transmitting application guidance on route selection policy rule determination from the application function in the second wireless communication network the network node is able to inform the policy control function in the first wireless communication network that it should create a route selection policy rule for particular application traffic when a user equipment roams to the second wireless communications network. After creation, such a route selection policy rule may then be transmitted to a user equipment such that the first wireless communication network is able to set route selection according to the identity of the network the user equipment is registered with. For example, if the network identity of the route selection descriptor matches the network identity of the wireless communication network the user equipment is registered with, then the route selection policy rule is applied to application traffic. In the above case the rule is set for a second wireless communication network that a user equipment may roam to. If the user equipment were to roam to the second wireless communication network, and register thereto, then the route selection policy rule comprising a network identity that is the second network identity would be applied to the application traffic that matches the route selection policy rule, in accordance with the transmitted application guidance on route selection policy rule determination.

The application guidance may include a validity condition. The validity condition comprises at least one of: an identity of the second wireless communication network; a plurality of identities of wireless communication networks; and/or an identity of an application.

The route selection policy rule may define a route for application traffic when a user equipment apparatus is registered in any wireless communication network having an identity matching one of the plurality of identities of wireless communication networks.

The network node may be triggered to send application guidance on route selection policy rule determination upon determining a desired user equipment specific handling of routing traffic to the second wireless communication network. Such a determination may be made when a particular class of application traffic exceeds some threshold.

The network node may be an Application Function. The Application Function may be an application function in a PLMN that is not the Home PLMN of the user equipment. The Application Function may be an application function in a PLMN other than the Home PLMN of the user equipment.

FIG. 8 illustrates a method 800 of a network node in a second wireless communication network. The network node may comprise an AF 134, 154, 234, 400 and/or 954 as described herein. The method 800 comprises sending 810 to a policy control function in a first wireless communication network, application guidance on route selection policy rule determination.

By transmitting application guidance on route selection policy rule determination from the application function in the second wireless communication network the network node is able to inform the policy control function in the first wireless communication network that it should create a route selection policy rule for particular application traffic when a user equipment roams to the second wireless communications network. After creation, such a route selection policy rule may then be transmitted to a user equipment such that the first wireless communication network is able to set route selection according to the identity of the network the user equipment is registered with. For example, if the network identity of the route selection descriptor matches the network identity of the wireless communication network the user equipment is registered with, then the route selection policy rule is applied to application traffic. In the above case the rule is set for a second wireless communication network that a user equipment may roam to. If the user equipment were to roam to the second wireless communication network, and register thereto, then the route selection policy rule comprising a network identity that is the second network identity would be applied to the application traffic that matches the route selection policy rule, in accordance with the transmitted application guidance on route selection policy rule determination.

There is further provided a network node in a first wireless communication network. The network node may be a NEF 132, 152, 232, 932. The network node may comprise a network node 400 as described with reference to FIG. 4, and comprising a processor 405, a receiver 435, and a transmitter 430. The network node comprises a receiver and a processor. The receiver is arranged to receive a request from an application function (AF) in a second wireless communication network, the request comprising service parameters identifying both a first application and a second wireless communication network. The processor is arranged to store the service parameters in a Unified Data Repository (UDR) of the first wireless communication network.

The network node may be a Network Exposure Function (NEF). The stored service parameters are applied by a Policy Control Function (PCF) in the first wireless communication network to create a route selection policy rule. The route selection policy rule indicates how the traffic of the first application is to be routed by a remote unit when the remote unit is registered with the second wireless communication network.

There is further provided a method of a network node in a first wireless communication network. The method comprises receiving a request from an application function (AF) in a second wireless communication network, the request comprising service parameters identifying both a first application and a second wireless communication network. The processor is arranged to store the service parameters in a Unified Data Repository (UDR) of the first wireless communication network. The network node may be a Network Exposure Function (NEF).

According to the methods and apparatus described herein, an AF at a VPLMN may provide guidance for URSP rules creation at a PLMN different to the HPLMN. In one use case, an Application Function in a VPLMN requires specific handling of UE application traffic. The AF in the visited PLMN (or a different PLMN) provides the service information re-using the service specific information provisioning procedure described in 3GPP TS 23.502 v17.3.0 with the difference that the AF includes an indication to apply this rule only for UEs targeted in a specific PLMN.

The trigger for the AF request could be due to: AF service provider of a VPLMN wishes to use specific DNN/S-NSSAI handling for roaming UEs. Additionally or alternatively, the trigger may be provided by the Network Slices Capability Enablement Server defined in 3GPP TS 25.434 v16.0.0. The NSCE server may be located in an AF. The NSCE server may receive from an NSCE client (located in a UE) a network/slice notification remapping for an application based on configuration provided by the NSCE server to the NSCE client in the UE.

The NEF stores the AF request information in the UDR in the “Application Data” field within the Service Specific Information Data Subset together with the assigned Transaction Reference ID (provided by the AF).

When the PCF receives the updated subscription information from the UDR the PCF derives updated URSP rules for a UE (or any UE) including in the URSP rule information indicating to the UEs to apply this URSP rules only when registering to a specific PLMN. In one embodiment PLMN information can be included as a separate validity condition within a Route Selection Descriptor. An example is shown in the Table below.

TABLE 1
Example PLMN validity indication in Route Selection Descriptor

| | | | PCF permitted | |
|---|---|---|---|---|
| Information | | | to modify in | |
| name | Description | Category | URSP | Scope |
| Route | Determines the order in | Mandatory | Yes | UE context |
| Selection | which the Route Selection | (NOTE 1) | | |
| Descriptor | Descriptors are to be | | | |
| Precedence | applied. | | | |
| Route | This part defines the route | Mandatory | | |
| selection | selection components | (NOTE 2) | | |
| components | | | | |
| SSC Mode | One single value of SSC | Optional | Yes | UE context |
| Selection | mode. | | | |
| | (NOTE 5) | | | |
| Network Slice | Either a single value or a | Optional | Yes | UE context |
| Selection | list of values of S- | (NOTE 3) | | |
| | NSSAI(s). | | | |
| DNN Selection | Either a single value or a | Optional | Yes | UE context |
| | list of values of DNN(s). | | | |
| PDU Session | One single value of PDU | Optional | Yes | UE context |
| Type Selection | Session Type | (NOTE 8) | | |
| Non-Seamless | Indicates if the traffic of the | Optional | Yes | UE context |
| Offload | matching application is to | (NOTE 4) | | |
| indication | be offloaded to non-3GPP | | | |
| | access outside of a PDU | | | |
| | Session. | | | |
| ProSe Layer-3 | Indicates if the traffic of the | Optional | Yes | UE context |
| UE-to-Network | matching application is to | (NOTE 4) | | |
| Relay Offload | be sent via a ProSe Layer- | | | |
| indication | 3 UE-to-Network Relay | | | |
| | outside of a PDU session. | | | |
| Access Type | Indicates the preferred | Optional | Yes | UE context |
| preference | Access Type (3GPP or | | | |
| | non-3GPP or Multi-Access) | | | |
| | when the UE establishes a | | | |
| | PDU Session for the | | | |
| | matching application. | | | |
| PDU Session | An indication shared by | Optional | Yes | UE context |
| Pair ID | redundant PDU Sessions | | | |
| | as described in | | | |
| | clause 5.33.2.1 of | | | |
| | TS 23.501 [2]. | | | |
| RSN | The RSN as described in | Optional | Yes | UE context |
| | clause 5.33.2.1 of | | | |
| | TS 23.501 [2]. | | | |
| Route | This part defines the Route | Optional | | |
| Selection | Validation Criteria | | | |
| Validation | components | | | |
| Criteria | | | | |
| (NOTE 6) | | | | |
| Time Window | The time window when the | Optional | Yes | UE context |
| | matching traffic is allowed. | | | |
| | The RSD is not considered | | | |
| | to be valid if the current | | | |
| | time is not in the time | | | |
| | window. | | | |
| Location | The UE location where the | Optional | Yes | UE context |
| Criteria | matching traffic is allowed. | | | |
| | The RSD rule is not | | | |
| | considered to be valid if the | | | |
| | UE location does not | | | |
| | match the location criteria. | | | |
| PLMN | The PLMN where the UE is | | | |
| indication | registered where the | | | |
| (new) | matching traffic is allowed. | | | |
| | The RSD is not considered | | | |
| | to be valid if the PLMN | | | |
| | Indication does not match | | | |
| | the registered PLMN of the | | | |
| | UE. | | | |

In an alternative embodiment PLMN validity condition can be included within UE location validity information.

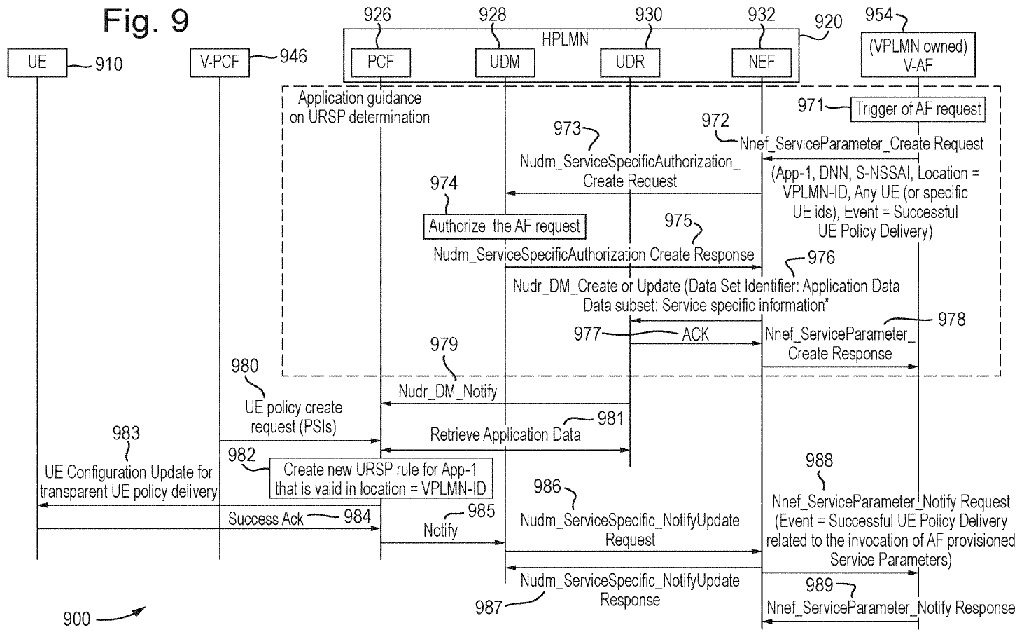

FIG. 9 is a signaling diagram illustrating a procedure to for a VPLMN to influence URSP rules for UEs roaming from a different PLMN. A UE 910 communicates with a Home PLMN 920. The home PLMN 920 comprises a PCF 926, a UDM 928, a UDR 930 and a NEF 932. The Visited PLMN (VPLMN) comprises a Visited AF (V-AF) 954 and a Visited PCF (V-PCF) 946.

At 971, the AF in VPLMN is triggered to request to the home PLMN of a UE a specific handling of routing traffic to the VPLMN

At 972, the AF invokes a service operation with the NEF including in the request updated service information. The updated information includes a validity condition to apply a URSP rule in a specific PLMN. The validity information may also include a list of VPLMNs. This procedure is described in 3GPP TS 23.502 v17.3.0, clause 4.15.6.10. The request is applicable for any UE or the AF may include domain information and/or external identifiers of the UE.

At 973, the NEF 932 sends an authorization request to the UDM 928, byway of a Nudm_ServiceSpecificAuthorization-Creat Request message. At 974, the UDM 928 authorizes the request. At 975 the UDM sends authorization to NEF 932 byway of a Nudm_ServceSpecificAuthorization_Create Response message. Steps 973 to 975 may be performed in accordance with 3GPP TS 23.502 v17.3.0.

At 976, in response to successful authorization, the NEF 932 updates the data in the UDR 930 including within Application Data the updated service information. The NEF 932 invokes an Nudr_DM_Create (or Update) service request that requests the UDR 930 stores the service information in the “Application Data” Data Set within the Service Specific Information Data Subset identifier. The NEF 932 may also include a Data Key indicating the target UEs or Group of UEs. In one embodiment that service information is stored within the existing Service Information parameters including as Data Key the S-NSSAI or DNN of the service information (if the request is for any UE).

At 977, the UDR 930 acknowledges the NEF request.

At 978, the NEF 932 acknowledges the AF request

At 979, if the PCF 926 has subscribed to Service Specific Information the UDR 930 notifies the PCF 926 of the updated service information.

At 980, when the UE 910 registers to the HPLMN 920 (or the VPLMN) the UE 910 may include a list of Public Service Identities (PSIs). An AMF (in HPLMN) or (as illustrated in FIG. 9) the V-PCF 946 (in VPLMN) initiates the UE 910 Policy Association Create request with the PCF 926 including in the request the list of PSIs associated to the HPLMN 920.

At 981, the PCF 926 retrieves Application Data subscription information from the UDR 930.

At 982, the PCF 926 creates updated URSP rules including URSP rules with validity conditions on per a PLMN basis according to the information stored in the UDR 930.

At 983, the PCF 926 provides updated URSP rules to the UE 910 by initiating a UE Configuration Update for transparent policy delivery (via the V-PCF 946 if the UE is roaming) to deliver an updated URSP rule to the UE 910.

At 984, the UE 910 acknowledges successful installation of rules.

At 985, if the V-AF 954 has subscribed to notification of successful policy delivery the PCF 926 notifies the UDM 928.

At 986, the UDM 928 informs the NEF 932 of successful policy delivery. At 987 the NEF 932 acknowledges this.

At 988, the NEF 932 informs the V-AF 954 of successful policy delivery. At 989, the V-AF 954 acknowledges this.

Upon reception of the URSP rules including PLMN validity conditions, the UE 910 enforces the URSP rules as follows:
When the UE finds that application traffic matches traffic descriptor of a URSP rules the UE checks the list of Route Selection Descriptors of the matched URSP rule.
If an RSD in the list of RSDs contains PLMN validity conditions the UE checks if the PLMN identity within the validity conditions matches the PLMN identify of the registered PLMN or an equivalent PLMN of the registered PLMN.
If there is match the UE considers the RSD valid and routes the application traffic according to the contents of the route selection descriptor.
If there is no match the UE considers the RSD as invalid and continues to process a second RSD in the list of RSD of the matched URSP rules if available.
If no other RSD match the UE considers the URSP rule not matched and processes a different URSP rule.

Currently URSP rules are provided only by the HPLMN and the UE applies the same URSP rules in any PLMN that the UE registers to. This creates issues in case, when a UE is roaming, the VPLMN operator may require a specific traffic routing handling of a specific application different to that required by the HPLMN.

As part of Release 18 work, 3GPP SA2 will identify how the V-PLMN can influence the H-PLMN to create and provision URSP rules. This document provides a solution that tends to allow an HPLMN to identify that specific URSP rules are needed in a VPLMN. This document additionally provides a solution that tends to define how are URSP rules are configured to allow the UE to determine to apply the URSP rules in a particular VPLMN.

According to a solution provided herein, the AF in a different PLMN (i.e. a Visited PLMN for a UE) provides to the HPLMN information that assists the HPLMN in creating URSP rules that the UE can use when registered to that VPLMN. A new configuration of a URSP rule is provided to include a validity condition in the route selection descriptor of the URSP rules to allow the UE to determine that the route selection descriptor is valid only when the UE is registered to a specific VPLMN.

It is known that the AF may provide guidance to a PLMN for URSP rule creation. According to the solutions provided herein, URSP rules for a different PLMN can be created.

Accordingly, there is provided a PCF arranged to construct URSP rules for a different VPLMN by including validity conditions in the route selection descriptor of the URSP rule.

There is further provided a Network Exposure Function (NEF) in a first mobile communication network configured to: receive a request from an application function (AF), the request providing service parameters for a first application, wherein the service parameters comprise a first indication indicating that the service parameters are to be applied in a second mobile communication network; store the service parameters in a Unified Data Repository (UDR) in the first mobile communication network; wherein: the stored service parameters are applied by a Policy Control Function (PCF) in the first mobile communication network to create a URSP rule, and wherein the URSP rule indicates how the traffic of the first application is to be routed by a remote unit when the remote unit is registered with the second mobile communication network. The first indication may be the VPLMN-ID.

There is further provided a Policy Control Function (PCF) in a first mobile communication network, the PCF arranged to receive a notification from a UDR of updated Service Specific Information for a UE, a group of UEs or a S-NSSAI/DNAI combination; determining from the Service Specific Information a specific handling of application traffic routing in a second mobile communication network; construct a URSP rule including a validity condition in the route selection descriptor to apply the content of the route selection descriptor when the device is registered in a second mobile communication network.

There is further provided a UE in a first mobile communication network arranged to receive URSP rules from a second mobile communication network; detect application traffic that matches an application descriptor within a URSP rule, determine that a route selection descriptor within the matched URSP rules contains a validity conditions for a PLMN, and apply the route selection descriptor components of the matched URSP rule upon determining the PLMN identifier in the validity condition matches the PLMN identify of the first mobile communication network.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communications standards, these examples are not intended to be the limit of the communications standards to which the disclosed method and apparatus may be applied. For example, while specific examples have been given in the context of 3GPP, the principles disclosed herein can also be applied to another wireless communications system, and indeed any communications system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A user equipment (UE) for wireless communication, comprising:
at least one memory; and
at least one processor coupled with the at least one memory and configured to cause the UE to:
receive a route selection policy rule, the route selection policy rule comprising an application descriptor- and a route selection descriptor, the route selection descriptor comprising a network identity;
detect application traffic that matches the application descriptor;
determine that the network identity of the route selection descriptor matches an identity of a first wireless communication network; and
apply the route selection descriptor to the detected application traffic based at least in part on a determination that the network identity of the route selection descriptor matches the identity of the first wireless communication network.

2. The UE of claim 1, wherein the first wireless communication network is-comprises a home network for the UE.

3. The UE of claim 1, wherein the route selection policy rule is received from the first wireless communication network.

4. The UE of claim 1, wherein the first wireless communication network comprises a visited network for the UE.

5. The UE of claim 1, wherein a second wireless communication network comprises a home network for the UE, and wherein the route selection policy rule is received from the second wireless communication network.

6. The UE of claim 1, wherein the route selection policy rule comprises a route selection validation criteria, the route selection validation criteria comprising at least one of:
the network identity;
a time window; or
a location criteria.

7. A method performed by a user equipment (UE), the method comprising:
receiving a route selection policy rule, the route selection policy rule comprising an application descriptor- and a route selection descriptor, the route selection descriptor comprising a network identity;
detecting application traffic that matches the application descriptor;
determining that the network identity of the route selection descriptor matches an identity of a first wireless communication network; and
applying the route selection descriptor to the detected application traffic based at least in part on a determination that the network identity of the route selection descriptor matches the identity of the first wireless communication network.

8. A network node in a first wireless communication network for wireless communication, comprising:
at least one memory; and
at least one processor coupled with the at least one memory and configured to cause the network node to:
construct a route selection policy rule comprising an application descriptor and a route selection descriptor, the route selection descriptor comprising a network identity, wherein the network identity identifies a second wireless communication network, and the route selection policy rule defines a route for application traffic when a user equipment (UE) is registered in the second wireless communication network; and
transmit the route selection policy rule to the UE.

9. The network node of claim 8, wherein the first wireless communication network is a home network for the UE, and wherein the second wireless communication network is a visited network for the UE.

10. The network node of claim 8, wherein the network node comprises a policy control function.

11. The network node of claim 8, wherein the at least one processor is configured to cause the network node to receive a notification of updated service parameters from a Unified Data Repository (UDR) in the first wireless communication network.

12. The network node of claim 11, wherein the at least one processor is further configured to cause the network node to determine from the updated service parameters a route for application traffic in the second wireless communication network.

13. The network node of claim 11, wherein the at least one processor is further configured to cause the network node to construct the route selection policy rule from the updated service parameters in accordance with a determined route for application traffic in the second wireless communication network.

14. The network node of claim 11, wherein the updated service parameters are for a-one or more of the UE, a group of UEs, or a combination of Single Network Slice Selection Assistance Information (S-NSSAI) and Data Network Access Identifier (DNAI).

15. (canceled)

16. A processor for wireless communication, comprising:
at least one controller coupled with at least one memory and configured to cause the processor to:
receive a route selection policy rule, the route selection policy rule comprising an application descriptor and a route selection descriptor, the route selection descriptor comprising a network identity;
detect application traffic that matches the application descriptor;
determine that the network identity of the route selection descriptor matches an identity of a first wireless communication network; and
apply the route selection descriptor to the detected application traffic based at least in part on a determination that the network identity of the route selection descriptor matches the identity of the first wireless communication network.

17. The processor of claim 16, wherein the first wireless communication network comprises a home network for a user equipment (UE).

18. The processor of claim 16, wherein the route selection policy rule is received from the first wireless communication network.

19. The processor of claim 16, wherein the first wireless communication network comprises a visited network for a user equipment (UE).

20. The processor of claim 16, wherein a second wireless communication network comprises a home network for a user equipment (UE), and wherein the route selection policy rule is received from the second wireless communication network.

21. The processor of claim 16, wherein the route selection policy rule comprises a route selection validation criteria, the route selection validation criteria comprising at least one of:
the network identity;
a time window; or
a location criteria.
